(19) United States
(12) Patent Application Publication
(10) Pub. No.: US 2007/0183369 A1
(43) Pub. Date: Aug. 9, 2007

(54) System for verifying restored outages, such as in the field outage restoration of public utilities using automatic meter reading (AMR)

(76) Inventor: Bruce Angelis, Spokane, WA (US)

Correspondence Address: PERKINS COIE LLP;PATENT-SEA, P.O. BOX 1247, SEATTLE, WA, 98111-1247, US

(21) Appl. No.: 11/702,415

(22) Filed: Feb. 5, 2007

Related U.S. Application Data
(60) Provisional application No. 60/765,497, filed on Feb. 3, 2006.
(60) Provisional application No. 60/764,823, filed on Feb. 3, 2006.

(51) Int. Cl. H04Q 7/00

(52) U.S. Cl. 370/332

(57) ABSTRACT

Systems and methods for verifying restored outages are described. In some examples, the system samples endpoints to determine an extent of a restoration. The system may compare positive indications received by endpoints to a list of endpoints that indicate utility outages, and provide guidance to a field worker based on the comparison.

### CROSS REFERENCE TO RELATED APPLICATIONS

This application claims priority to U.S. Provisional Patent Application No. 60/765,497, filed on Feb. 3, 2006, entitled SYSTEM FOR VERIFYING RESTORED OUTAGES, SUCH AS IN THE FIELD OF OUTAGE RESTORATION OF PUBLIC UTILITIES USING AUTOMATIC METER READING (AMR) (Attorney Docket No. 101458025US), and U.S. Provisional Patent Application No. 60/764,823, filed on Feb. 3, 2006, entitled OUTAGE NOTIFICATION, SUCH AS FIXED NETWORK POSITIVE OUTAGE NOTIFICATION Attorney Docket No. (101458026US), both of which are incorporated by reference in their entirety.

This application is related to U.S. patent application Ser. No. ______ (Attorney Docket No. 101458026US1), entitled OUTAGE NOTIFICATION, SUCH AS FIXED NETWORK POSITIVE OUTAGE NOTIFICATION, filed concurrently herewith, which is incorporated by reference in its entirety.

### BACKGROUND

Power outages and other service interruptions have long been a problem in the utility industry. Some causes of outages include, for example, storms (e.g., wind, heat, lightning, thunderstorms, snow, and so on), trees (which may contact power lines), vehicles (which may crash into utility poles), animals (may make contact with power lines), excavation and construction (which may damage underground cables), equipment failure, a high power demand event, and so on.

Many utilities use Outage Management Systems (OMS) for larger outage events to facilitate the coordination of outage notifications (e.g., SCADA alarm, or a call center receives a call from a customer) with restoration responses by a utility. For example, a typical OMS goes into action based on a customer call or an electronic notification from an automatic monitoring system. The OMS attempts to locate the problem causing the outage and, if successful, provides and prioritizes restoration options for the utility. The utility may then choose one or more restoration options, and typically workers travel to the located problem to repair the outage and, hopefully, restore power to an area.

If an outage occurs and is reported, a utility typically will send out a trained field worker to analyze the situation and fix the problem in order to restore service to an affected area. Field workers, however, are generally not fully equipped to verify the effects of their restoration work. In many cases, field workers make repairs in one location and proceed to the next damaged location, and so on. Often, earlier work does not accomplish or facilitate a complete restoration of power to all service points, so the field worker may need to return to a previously worked location. This backtracking may reduce the field workers' efficiency. These and other problems exist with respect to fixing power outages and restoring power and other utilities (such as water, gas, cable, and so on) in affected areas.

### BRIEF DESCRIPTION OF THE DRAWINGS

FIG. 1 is a block diagram of a mobile utility data collection and verification system that employs aspects of the invention.

FIG. 2 is a block diagram of an outage verification system of FIG. 1.

FIG. 3 is a data flow diagram illustrating suitable data flows that occur in determining outage information, and providing the information to a field worker.

FIG. 4 is a flow diagram illustrating a process for verifying outage restoration.

FIG. 5 is a block diagram illustrating a distributed network of potential outages.

### DETAILED DESCRIPTION

Described in detail below is a system to analyze (in the field or otherwise) automatic meter reading (AMR) service points that are restored after power outages. In some examples, the system collects device signals from AMR service points to determine and verify that power has been restored to areas proximate to a field worker. Once a field worker completes restoration work to an area affected by an outage, the system may verify the impact of the restoration work on the affected areas.

In some examples, the field worker employs a mobile device capable of storing identifications (IDs) of outage points in an area. (Prior AMR and other systems provide restoration flags or messages to indicate that power has been restored to an endpoint, and endpoints and fixed network systems can report back signals indicating which endpoints have been restored.) The mobile device receives the IDs and alerts the field worker to the suspected outage points. After completion of the restoration of an outage or outages, the mobile device may be used to collect data messages (such as by initiating a sampling activity) from AMR service points located proximate (or beyond) the recently restored outage point. The device may correlate the IDs with the collected messages to determine the extent of the restoration. In some examples, the mobile device, after determining the extent of a restoration, may alert the field worker to further outages and provide information relating to a need for additional repair work.

In some examples, the mobile device includes software that alerts a field worker of AMR devices that do not positively acknowledge restoration, and that supports “hunting down” restorations used to find and confirm the restoration of such AMR devices (or, alternatively, may find additional AMR devices that have not been restored). Using Global Positioning System (GPS) information and a field worker's location information, the system may provide an indication of outages that potentially have been restored and need to be confirmed either by the mobile device (such as received AMR device messages) or by the field worker (such as manual inspection of the AMR device).

Additionally, in some examples, the software supports cascading of restoration verifications. For example, when verifying performed restoration work, a field worker may locate other outages in a given area based on messages received (or a lack thereof) when attempting to verify the restoration of services within an area.

Various examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

### Representative System

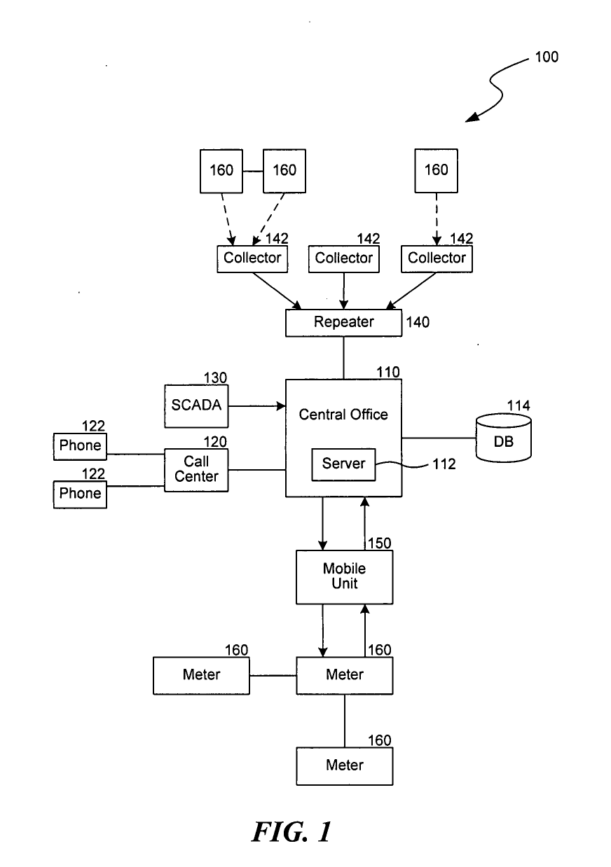

FIG. 1 and the following discussion provide a brief, general description of a suitable environment in which the invention can be implemented. Although not required, aspects of the invention are described in the general context of computer-executable instructions, such as routines executed by a general-purpose computer (e.g., wireless device, or personal/laptop computer). Those skilled in the relevant art will appreciate that the invention can be practiced with other communications, data processing, or computer system configurations, including Internet appliances, handheld devices (including personal digital assistants (PDAs)), wearable computers, all manner of cellular or mobile phones, embedded computers (including those coupled to vehicles), multi-processor systems, microprocessor-based or programmable consumer electronics, set-top boxes, network PCs, mini-computers, mainframe computers, and the like. Indeed, the terms “computer” and the like are generally used interchangeably and refer to any of the above devices and systems, as well as any data processor.

Aspects of the invention can be embodied in a special purpose computer or data processor that is specifically programmed, configured, or constructed to perform one or more of the computer-executable instructions explained in detail herein. Aspects of the invention can also be practiced in distributed computing environments where tasks or modules are performed by remote processing devices, which are linked through a communication network. In a distributed computing environment, program modules may be located in both local and remote memory storage devices.

Aspects of the invention may be stored or distributed on computer-readable media, including magnetically or optically readable computer disks, as microcode on semiconductor memory, nanotechnology memory, organic or optical memory, or other portable data storage media. Indeed, computer-implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or may be provided on any analog or digital network (packet switched, circuit switched, or other scheme. Those skilled in the relevant art will recognize that portions of the invention reside on a server computer, while corresponding portions reside on a client computer, such as a mobile device.

FIG. 1 illustrates an example of a mobile utility data collection and verification system 100 used to verify restoration work performed on problems that cause outage events. The system includes a central office 110 (which may house a central server 112 and database 114) in communication with a number of outage reporting components. Some of these components include a call center 120 that receives calls from customers 122 of the utility, a Supervisory Control and Data Acquisition (SCADA) unit 130 that provides automated outage information to the central office, and so on.

The central server 112 may include a host processing system and/or meter reading and verifying application(s) for processing meter restoration data. The host processing system 112 may be a head-end server computer. In some embodiments, the host processing system and/or meter reading and verifying application(s) 112 use customer information to create route files used when driving a route to verify restored meters. Examples of meter reading applications may include MV-RS™, Premierplus4™, Viena™, and Integrator™, all by Itron, Inc. of Spokane, Wash. The host processing system and/or meter reading and verifying application(s) 112 may operate in association with systems operated by a utility company, such as a utility billing system, or more generally, a customer information system (CIS). In this way, the host processing system and/or meter reading and verifying application(s) 112 can also communicate data to the mobile utility data collection and verification system 100. This information may include both route file and endpoint location file (ELF) data, which may be stored in a data store 114 prior to export from the billing system/CIS. However, in some embodiments, endpoint location files may also be transmitted directly from the billing system/CIS to the system 100. Likewise, data collected by the system 100 may be returned to host processing system and/or meter reading and verifying application(s) 112 for processing.

For example, customer 122 may use a utility's help line and call into a call center 120 to report a power failure (e.g., the power is out at their residence). A representative at the call center 120 (or, in some cases, an automated agent) then notifies the central office of an outage at the customer's residence. In another example, the central office may receive outage information from a SCADA unit 130 indicating that a small generator that provides power to a number of customers is no longer in service.

The central office may also receive information from a repeater 140 which communicates with many collectors 142 situated throughout a network of AMR devices 160. Collectors, which may collect messages and information from a variety of service points and AMR devices, transmit information signals to repeaters which then relay the information to the central office. By chaining together a network of collectors 140 and repeaters 142, the system is able to cover a large geographical area of AMR devices.

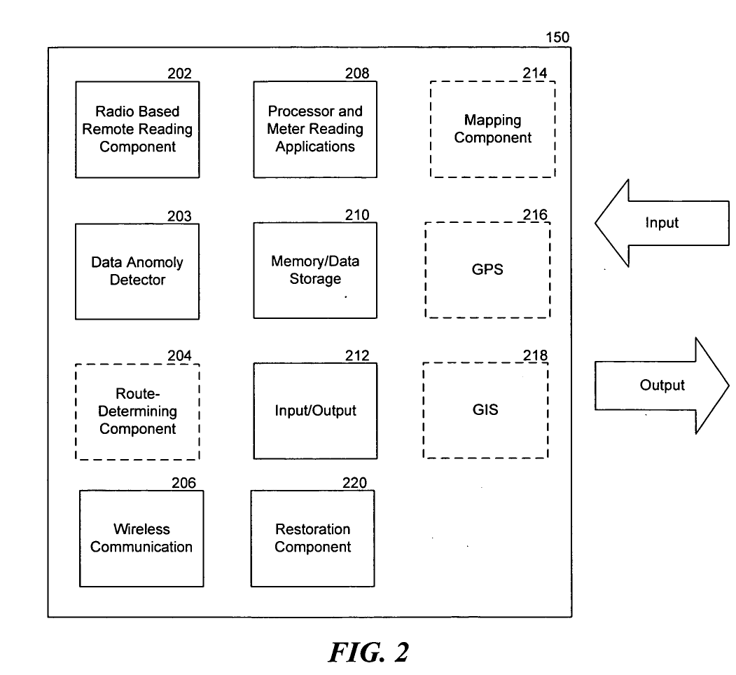

The central office 110 (via the central server 112) may communicate with a mobile unit 150 used to read information from AMR devices 160. The mobile unit 150 may be installed in a vehicle or be otherwise configured to be transported through a route (e.g., handheld). For example, the vehicle system may include the appropriate antennas, power supply, any necessary mounts, and so on. Of course, the system described herein can also be employed in a handheld device or other in-field devices. Further details regarding the mobile unit will be discussed with respect to FIG. 2.

FIG. 2 illustrates an example of the mobile unit 150 introduced in FIG. 1. The mobile unit 150 includes a remote reading component 202 (e.g., radio based), a data anomaly detector 203 (described below), and an optional sequencing component 204. In some embodiments, these and other portions of the mobile unit 150 may effectively be combined into a single system. For example, a single system incorporating many of the features required for collecting data from endpoints may be useful in identifying anomalous data and determining an optimal sequence for communicating with or verifying endpoints. Here, however, they are illustrated separately to demonstrate the distinct functions of the components.

The mobile unit 150 also includes a wireless component 206, which, in some, embodiments, may include an antenna and a transceiver (not shown). The transceiver of the wireless component 206 sends signals to wake up endpoints that function in “wake-up” mode to receive and manage incoming data. A processor with meter-reading and other applications 208 provide capabilities to control several processes, including managing collected data, initiating sampling activity and receiving messages from sampled meters, and other functions described herein.

The mobile unit 150 may store verification data (and other information such as collected data) in a memory or other storage device 210 associated with the mobile unit 150, such as a non-volatile memory. For example, the memory 210 can store not only verification data (e.g., messages received from AMR devices during field worker initiated sampling), but also other collected data, route information, performance, communications statistics, history, and other data noted herein. As described below, the memory 210 can store both internal and external data within the in-field unit 150, to thereby avoid the need for the unit to access a database at the central office 110. The memory may also store AMR device identifications of potential outages received from the central office.

A user input/output component 212 provides an appropriate user interface for an operator of the mobile unit 150. For example, the mobile unit 150 may provide a color touchscreen display for ease of use, and for clear graphical displays. Other user input/output options are possible, including mouses, microphones, speakers, joysticks, keyboards, LCD screens, audio, and so on. One application of the input/output component 212 includes displaying and controlling mapping images generated by an optional mapping component 214. In this way, the field worker is provided with feedback, so that he or she can determine which restorations have been verified on a particular route and so he or she can view endpoints on the route in relation to the vehicle and to other endpoints. The input/output component 212 and mapping component 214 can graphically display restored meters for in-field verification by the field worker, as described below. Global Positioning System (GPS) 216 or Geographical Information System (GIS) 218 components may also be included. Further details regarding mapping and location determining components may be found in commonly assigned U.S. patent application Ser. No. 11/064,433, entitled Utility Endpoint Communication Scheme, Such as for Sequencing the Order of Meter Reading Communications for Electric, Gas and Water Utility Meters, filed Feb. 22, 2005, and application Ser. No. 10/903,866, filed Jul. 30, 2004, entitled Mapping in Mobile Data Collection Systems, Such as Utility Meter Reading And Related Applications.

Mobile unit 150 may also contain software 220 used to correlate messages received during sampling activities with AMR device information. Details regarding software 220 will be discussed in greater detail herein.

The remote unit 150 is configured to collect data from utility meters discussed above. The utility meters 160 may be of the same or different types. The system and remote unit may collaborate with various utility meters (and, utilities), such as electric, gas, water, or other (not shown)). Additionally, the system may facilitate the restoration methods described herein for data utilities, such as cable utilities, network utilities (such as Internet provisions), and so on. The utility meters 160 may be distributed in a bounded or unbounded geographical area. Each utility meter is connected to or associated with a utility consuming facility. For example, a utility meter may correspond with a household, a commercial facility, or another utility consuming facility or device.

While not illustrated in detail, each meter 160 includes a storage component for storing collected data before transmission to a data collection system. The storage component may also store information identifying the meter, such as a meter identification number. In addition, each meter may be configured with a receiver/transmitter telemetry device (e.g., an encoder receiver transmitter (ERT)) capable of sending and receiving signals to and from the remote unit 150. In general, these components (meter, storage, and telemetry device) may be collectively referred to as an “endpoint.” However, the term “endpoint” may herein refer to any one of a number of possible configurations for locally collecting data, such as utility consumption data, and not only the sample configuration described above.

In some examples, the remote unit is configured to send a wake-up signal to an endpoint. The received wake-up signal prompts the endpoint to transmit meter reading data to the mobile data collection system 150. In alternative embodiments, “bubble-up” (broadcast) techniques are used instead of the “wake-up” technique described above. In yet other embodiments, the mobile data collection system 150 is capable of point-to-point communications with specific endpoints.

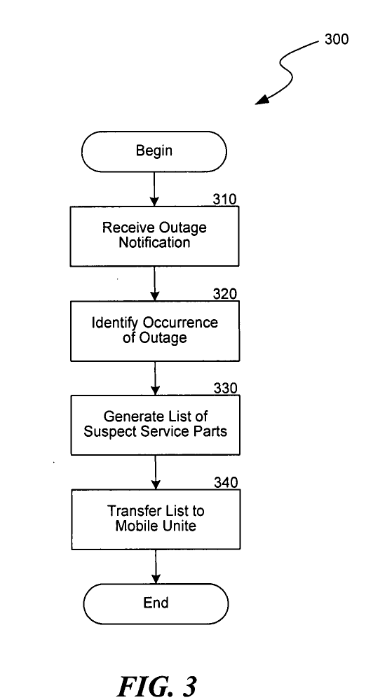

Referring to FIG. 3, an example of data flows in determining outage information and providing the information to a field worker is shown as a routine 300. Beginning at block 310, the system 300 receives an outage notification(s) 310 via call center 120, SCADA 130 or other information devices. In block 320, the routine uses the information received in block 310 and identifies the likely occurrence of an outage, such as a power failure caused by storm damage, and a likely location to be serviced to address the outage. In block 330, the routine also generates a list of service points (endpoints) likely impacted based on the identified outage occurrences. For example, the list may contain a single endpoint impacted or to be serviced, or a number of endpoints, based on the type and scale of the outage. The list may also contain information corresponding to the AMR device identification of the endpoints, the location information (GPS), or other information useful to the field worker. In block 340, the routine transfers the list of service points and related information to the mobile unit 150 so a field worker can begin to work on restoring the outage.

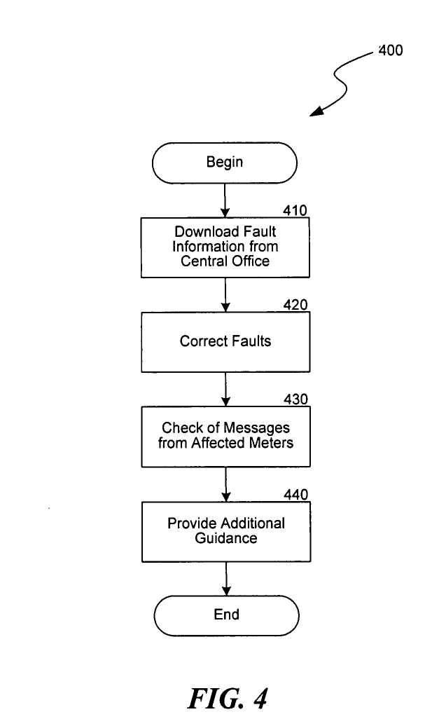

Referring to FIG. 4, an example of a procedure used in correcting and verifying restored service points is shown as a routine 400. Beginning at block 410, the system downloads fault information for restoration, and the list of service points that have likely been impacted from the central office via wireless component 206 of mobile unit 150. In block 420, a field worker corrects faults by performing the necessary field work to correct the outage.

The routine proceeds to block 430, where the field worker, via the mobile unit, checks for messages from meters affected by the outage after completing the restoration. As discussed above, the field worker may use the mobile unit to initiate a sampling activity of all or a select number of endpoints within the affected area. Endpoints receiving this sampling may respond by transmitting messages back to the mobile unit, indicating their restoration. However, in some cases, endpoints perceived to be restored may not return messages, indicating further problems in the area that also need correction/maintenance.

The system may then collect the messages transmitted by the endpoints and correlate them to the AMR device identifications previously received by the remote unit 150. The correlation may indicate the extent of an outage restoration, and may indicate further work to be performed to correct one or more outages.

Based on this correlation, the system, in block 440, may provide additional guidance to a field worker, such as an indication of further endpoints that may still be affected by the outage. The routine may provide instructions to help the field worker locate and correct a local fault to restore service to the endpoints still affected. Alternatively, the routine may generate work orders indicating additional work to be performed at a later time.

If a correlation of received AMR device messages and previously stored AMR device identifications indicates that not all endpoints have been successfully restored, the system may provide information related to “hunting down” operations. The software 220 located within the mobile unit may contain an algorithm (or algorithms) used to determine a route of affected endpoints in order to assist the field worker in such cases. The route may be helpful in recommending to the field worker a street level path of endpoints to use in finding an outage. For example, a field worker may proceed through a network of affected endpoints by using GPS location information and restoration verification information. In this example, the field worker uses positive confirmations of restoration to move through an affected area and find a suspected fault. Additionally, the route information may include way-points to repeaters (such as fixed network repeaters), as repeaters may confirm restoration on behalf of AMR devices.

During the hunting down operations, the field worker may locate other outages to be corrected while in the area. The field worker, upon correcting the additional problems, may restart the restoration verification process after performing the necessary repairs, leading to the cascading of verifications in a given area. The system may save the cascading of restoration verifications and use them to backtrack to suspected outages.

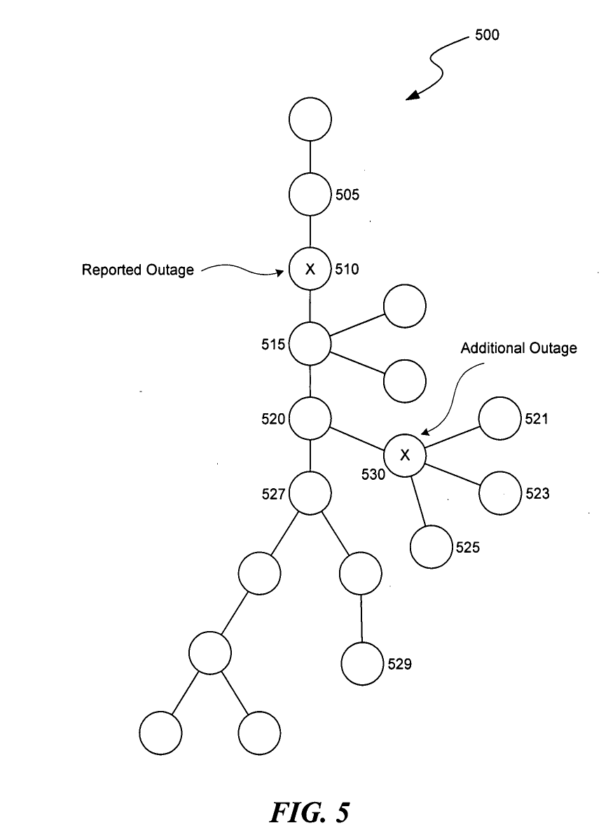

Restoration verification information may also be useful in preventing or foreseeing outages. FIG. 5 illustrates an example of a distributed network of endpoints in an area affected by an outage. Endpoints 510, 515, 520, 521, 523, 525, 527, and 529 are linked together via network 500. The diagram shows how an unreported outage may be detected during the restoration of other outages located downstream in a network of meters. For example, a field worker may receive and download information indicating an outage located proximate to endpoint 510. After fixing the outage associated with endpoint 510, the field worker attempts to gather messages from downstream endpoints to ensure that all downstream endpoints have been restored. However, the remote unit 150 may not receive messages from endpoints 521, 523 and 525. Based on stored route maps, network diagrams, or other data, the field worker may traverse downstream and attempt to identify an additional outage, which in this case corresponds to outage 530. The remote unit may provide instructions to the field worker regarding suspected locations of the additional outage 530 based on the fact that endpoints 521, 523 and 525 are all simultaneously out. After identifying and correcting the outage 530 while the field worker is in the area, the remote unit 150 again attempts to receive messages from the affected endpoints. In this example, assuming that the remote unit receives appropriate messages from the endpoints 521, 523 and 525 (in addition to additional endpoints, such as 527 and 529), the field worker can then move on to other areas of the network (not shown) to address other outages.

As another example, the field worker may fix outage 525 and use the system to verify the restoration of the outage at endpoint 525. Despite the field worker correcting the reported problem, the endpoint 525 may not respond to the sampling activity confirm the restoration of power. In this example, there may be additional outages (possibly unreported) upstream in the network, unrelated to the problems causing a customer at endpoint 525 to report a problem. Using route/network information located within the remote unit 150, the field worker moves upstream in the network to meter 520 and attempts to verify endpoint 520. Should meter 520 not provide any restoration indication messages, the field worker may attempt further to locate and correct the additional problem, traveling upstream in the network. The field worker may receive additional information, or may personally check networked endpoints. The network route information may lead the field worker to locate an outage at endpoint 510 (possibly because a message was received by endpoint 505). After correcting the outage, the field worker may again begin a sampling activity in order to confirm the restoration of power within the networked area.

As described above, the system may utilize the in field verification of restored endpoints (or lack thereof) to provide details to the central office of additional problems affecting an area. This information may be useful in indicating additional outages that have yet to be reported. This way, the system may anticipate problems before receiving calls from a customer. The system may use the information to generate future work orders in a quick and efficient manner, to call customers indicating the utility has located a problem and is in the process of correcting the problem, and so on.

Many alternatives are possible beyond the examples described above. For instance, rather than downloading and transferring the list of endpoints suspected to be out as a result of some outage, the system may wirelessly transfer such information, as needed, to the remote unit 150, while the field worker and the remote unit are in the field. For example, a fixed network system, cellular telephone system, wide area network, or other wireless technologies may be used to transfer data from the central office 110 to the mobile unit 150. Indeed, the system may employ a fixed network of endpoints, rather than the ERT type of AMR system described above. Furthermore, while generally described above with respect to restoring outages for public utility network, the invention may be employed with other networks, such as network of cable television endpoints, phone service networks (wired or wireless), etc. The system may also be used with other public utilities, such as water and gas, but the system may need to predict consumption of the utilities when the outage is restored, because often gas and water meters employ bubble-up ERTs that would need to provide some indication of consumption to indicate that they are back online, and thus that the outage has been corrected.

As noted above, the remote unit 150 can provide guidance to the field worker regarding additional outages to be corrected while the field worker is within the vicinity, to thereby help with, for example, nested outages. The remote unit may provide a map or route to the field worker to drive or walk to thereby check for such downstream outages and help identify the fault, as noted above. Such detection can be done visually by the field worker, or the remote unit could provide information to the field worker as to a suspected location of a downstream fault where the remote unit includes information regarding the electrical distribution system within the vicinity. Further, the remote unit may provide additional details to the worker, such as warnings (beware of vicious dog, obscure location of meter/equipment), directions to the next endpoint, locations of possible outages, locations to search for outages, and so forth.

As noted above, the system can provide for work orders for additional work to be handled at a later time. The remote unit 150 may automatically transmit back to the central office 110 the identification of those downstream outages that have still yet to be addressed. The central office 110 can then automatically generate work orders that are provided to additional field workers to be handled at a later time. The remote unit (or central office) may determine automatically that a more urgent restoration is needed, as opposed to handling a small nested outage, and thus such a work order may be generated. Further, the central office 110 may provide information to the call center 120 so that operators, or an automated system, can provide notifications to customers that work has begun to restore an outage, that the company is aware of the outage and is working to address it, that a work order has been sent to handle the outage within X number of days, or other notices. Such notices provide or increase customer support, and customer satisfaction, which can reduce potential fines.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description describes certain embodiments of the invention, and describes the best mode contemplated, no matter how detailed the above appears in text, the invention can be practiced in many ways. Details of the data collection and processing system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

We claim:

1. One or more mobile data processing devices, wherein at least one mobile data processing device is configured for wirelessly receiving data from multiple utility meters associated with a supplied utility, the one or more devices collectively comprising:
a data collection component, wherein the data collection component wirelessly receives data from the multiple utility meters, wherein the data relates to consumption of the utility or relates to resumption of the utility at the utility meter; and
an outage restoration component, wherein:
when the outage restoration component receives an indication from at least one of the multiple utility meters that an outage associated with the utility meter has been corrected, at least one of the processing devices indicates to a field worker a confirmation of the outage being corrected; and
when the outage restoration component receives an indication from the utility meter that the outage associated with the utility meter has not been corrected, at least one of the processing devices indicates to the field worker guidance information related to a possible outage located downstream from the outage.

2. The devices of claim 1, further comprising:
a geographic information component, wherein the geographic information component contains location information related to locations of other utility meters associated with the utility; and
a guidance component, wherein the guidance component retrieves the location information from the geographic information component and creates the guidance information that directs the field worker to the possible outage located downstream from the outage.

3. The devices of claim 2, wherein the geographic information component includes a global positioning system module.

4. The devices of claim 2, wherein the geographic information component includes a displayable map containing information related to locations of utility meters associated with the utility.

5. A method of positively verifying restoration work performed on outages associated with a utility, the method comprising:
storing meter identification information on a mobile data communication device, wherein the meter identification information includes information regarding two or more utility meters affected by the outage;
at the mobile data communication device, receiving signals from at least one of the two or more utility meters,
at the mobile data communication device, analyzing the received signals to extract positive indications that the at least one utility meter is associated with a restored outage of the utility;
at the mobile data communication device, comparing the extracted positive indications to the stored meter identification information to determine any additional outages not restored based on the comparison.

6. The method of claim 5, further comprising:
at the mobile data communication device; initiating a sampling activity of the two or more utility meters, wherein the sampling activity causes at least one of the two or more utility meters to transmit a signal.

7. The method of claim 5, further comprising:
retrieving geographic information related to a location of the mobile data communication device and related to locations of utility meters that do not transmit positive indications; and
providing direction information to a worker associated with the mobile data communication device based on the retrieved geographic information.

8. The method of claim 5, further comprising:
retrieving geographic information related to a location of the mobile data communication device and related to addresses of utility meters that do not transmit positive indications; and
providing street route information to a worker associated with the mobile data communication device based on the addresses.

9. The method of claim 5, further comprising:
providing statistical information to an outage restoration system, wherein the statistical information relates to the analyzed signals.

10. A computer-readable medium whose contents cause a mobile data capture device to perform a method of guiding a field worker associated with the mobile data capture device to an outage of a utility associated with a utility consuming facility, the method comprising:
at the mobile data capture device, receiving a signal from a first endpoint associated with the utility, wherein the signal provides an indication that the outage has been restored after the outage has been restored; and
when the first endpoint does not return a signal indicating the outage has been restored:
at the mobile data capture device, retrieving location information identifying other endpoints related to the outage of the utility and located downstream from the first endpoint;
at the mobile data capture device, comparing the identified location information with a location of the field worker; and
at the mobile device, providing guidance information to the field worker based on the comparison, wherein the guidance information relates to restoration of the outage.

11. The computer-readable medium of claim 10, further comprising:
at the mobile data capture device, transmitting a signal to a second endpoint determined by the comparison.

12. The computer-readable medium of claim 10, wherein the location of the field worker relates to geo-location coordinates of the field worker.

13. The computer-readable medium of claim 10, wherein the location of the field worker relates to location information input to the mobile data capture device by the field worker.

14. The computer-readable medium of claim 10, wherein the guidance information relates to a displayable map of locations of the downstream endpoints.

15. The computer-readable medium of claim 10, wherein the guidance information relates to directional information providing a street-level from the location of the field worker to the location of at least one of the downstream endpoints.

16. The computer-readable medium of claim 10, wherein the guidance information relates to information specific to at least one of the downstream endpoints.
